(19) United States
(12) Patent Application Publication
(10) Pub. No.: US 2022/0161066 A1
(43) Pub. Date: May 26, 2022

(54) RESPIRATOR DEVICE WITH COMMON INHALATION AND EXHALATION FILTERS

(71) Applicant: Dentec Safety Specialists Inc., Newmarket (CA)

(72) Inventor: Claudio DENTE, Newmarket (CA)

(21) Appl. No.: 17/528,397

(22) Filed: Nov. 17, 2021

(30) Foreign Application Priority Data
Nov. 23, 2020 (CA) 3100367

(51) Int. Cl. A62B 18/02; A62B 23/02

(52) U.S. Cl. CPC A62B 18/025; A62B 18/08; A62B 23/02

(57) ABSTRACT

A respirator includes a mask configured to snugly fit over the mouth and nose of a user in order to form an airtight seal over the mouth and nose of the user. The mask defines two openings for permitting airflow therethrough. A filter housing is attachable to said mask over each opening. The filter housing has inner and outer surfaces and an internal space theretween for receiving an air filter. The filter housing has an airflow opening in airflow communication with the opening when the filter housing is attached to the mask. The mask does not have a separate exhalation valve and is airtight such that upon sealing engagement of the mask over the mouth and nose of a user, air flows through the filters into the mask upon inhalation of the user and wherein air flows out of the mask through the filters upon exhalation of the user.

### FIELD OF THE DISCLOSURE

The present disclosure is directed to a reusable respirator device for safety purposes.

### BACKGROUND AND SUMMARY OF THE DISCLOSURE

Reusable respirator devices, typically half mask respirators, provide safety to workers in environments where the air contains harmful particulates such as silica dust, harmful gases, vapors or other toxins. Half mask respirator devices cover only the mouth and nose of the user and typically include inhalation valves located on the sides of the mask and an exhalation valve located on the front of the mask adjacent to the mouth of the user.

Respirator devices must meet strict regulatory requirements set by The National Institute for Occupational Safety and Health (NIOSH) for a number of criteria including breathing resistance and filter efficiency. It is of critical importance that the mask form an effective seal over the mouth and nose of the operator in order to prevent leakage. In addition, the mask must avoid excessive heat buildup inside the mask and must be comfortable during use.

The Covid-19 pandemic has presented additional health risks to workers in environments where the use of a respirator is required to avoid exposure to dangerous particulates, gases and vapors. Because with standard respirators, workers exhale through an unfiltered exhalation valve into the environment, co-workers are potentially exposed to the spread of Covid-19 and other viruses. There is therefore the need for a respirator where air is inhaled and exhaled through a filter in order to minimize the transmission of Covid-19 and other viruses while preserving protection to the user from harmful particulates gases, vapors and other toxins in the work environment. This need has previously not been achievable due to challenges in meeting NIOSH requirements for breathing resistance in addition to challenges in avoiding excessive heat buildup inside the mask and maintaining an acceptable seal and comfort for the user.

The present disclosure is directed to a respirator comprising a mask formed of an elastomeric material or silicone having a common filter through which a user inhales air from the surrounding environment and exhales air back into the environment. The filter meets NIOSH requirements for breathing resistance and filter efficiency. The respirator does not have a separate exhalation valve, so air is inhaled and exhaled through the common filter thereby providing protection against the spread of Covid-19 and other viruses. Preferably, the respirator has two filters housed in two separate filter housings through which air is both inhaled and exhaled. Preferably, the filter housings are located on the sides of the mask

According to one aspect of the present disclosure, there is provided a mask configured to snugly fit over the mouth and nose of a user in order to form an airtight seal over the mouth and nose of the user; said mask defining an opening for permitting airflow through said opening; a replaceable filter being attachable to the mask over said opening of said mask, wherein the mask is airtight such that upon sealing engagement of the mask over the mouth and nose of a user, air flows through the filter into the mask upon inhalation of the user and wherein air flows out of the mask through the filter upon exhalation of the user.

According to another aspect of the present disclosure, there is provided a respirator comprising: a mask configured to snugly fit over the mouth and nose of a user in order to form an airtight seal over the mouth and nose of the user; said mask defining an opening for permitting airflow through said opening; a replaceable filter housing being attachable to the mask over said opening of said mask, the filter housing including an inner support member for attachment to the mask, the inner support member defining an opening corresponding to the opening of the mask when the filter housing is attached to the mask, the filter housing further including an outer support member defining an opening for permitting airflow, the filter housing defining a space between the inner support member and the outer support member for receiving a filter, wherein the mask is airtight such that upon sealing engagement of the mask over the mouth and nose of a user, air flows through the filter housing into the mask upon inhalation of the user and wherein air flows out of the mask through the filter housing upon exhalation of the user.

According to another aspect of the present disclosure, there is provided a respirator comprising a mask configured to snugly fit over the mouth and nose of a user in order to form an airtight seal over the mouth and nose of the user; said mask defining two openings for permitting airflow through said openings; two filter housings, each of said two filter housings being detachably attachable to said mask over a respective one of said openings of said mask, each of the filter housings having an inner support member attachable to one of said openings and an outer support member, each of the filter housings defining an internal space between the inner support member and an outer surface for receiving an air filter, the inner support member defining an airflow opening in airflow communication with the opening of the mask when the filter housing is attached to the mask, the outer support member defining an airflow opening; wherein the mask is airtight such that upon sealing engagement of the mask over the mouth and nose of a user, air flows through the filter housings into the mask upon inhalation of the user and wherein air flows out of the mask through the filter housings upon exhalation of the user.

Additional features and advantages of the present disclosure will become apparent to those skilled in the art upon consideration of the following detailed description of the illustrative embodiments exemplifying the best mode of carrying out the embodiments of the present disclosure as presently perceived.

### BRIEF DESCRIPTION OF THE DRAWINGS

The detailed description of the drawings particularly refers to the accompanying figures in which:

FIG. 1 is a front view of a respirator mask assembly of the present disclosure;

FIG. 2 is a front view of a respirator mask of the present disclosure as attached to a connector and a strap of the present disclosure;

FIG. 3 is a front view of a respirator mask of the present disclosure as attached to connectors of the present disclosure;

FIG. 4; is a rear view of a respirator mask of the present disclosure as attached to the strap and the connectors of the present disclosure;

FIG. 5 is a front view of the mask of the present disclosure;

FIG. 6 is a front view of a connector as attached to the mask of the present disclosure;

FIG. 7 is a perspective view of an inner surface of an inner support member of a filter housing of the present disclosure;

FIG. 8 is a perspective view of an outer surface of an inner support member of the filter housing of the present disclosure;

FIG. 9 is perspective view of an outer surface of the preferred embodiment of an outer support member of the filter housing of the present disclosure FIG. 10 is perspective view of an outer surface of an alternate embodiment of an outer support member of the filter housing of the present disclosure;

FIG. 11 is a perspective view of the alternate embodiment of the outer support member shown in FIG. 10 with a filter pad housed in an inner surface thereof;

FIG. 12 is a perspective view of the strap of the present disclosure;

FIG. 13a is a front perspective view of a second alternate embodiment of the filter housing of the present disclosure; and

FIG. 13b is a rear perspective view of the second alternate embodiment of the filter housing of the present disclosure.

### DETAILED DESCRIPTION

The embodiments of the present disclosure described herein are not intended to be exhaustive or to limit the present disclosure to the precise forms disclosed.

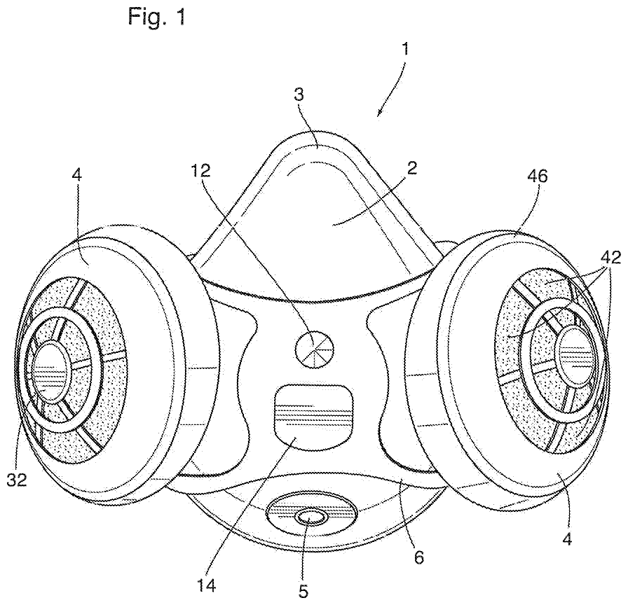

With reference initially to FIG. 1, an illustrative respirator 1 is illustrated. The respirator 1 includes a mask 2. Preferably the mask 2 is a half mask that covers the mouth and nose of the individual user of the mask. Another embodiment of the respirator could include a full mask that covers the entire face of the user including the user's eyes.

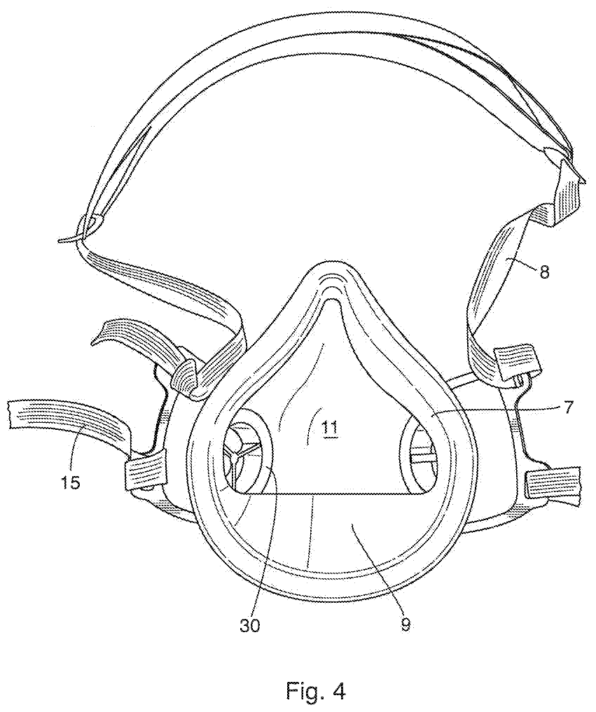

The mask 2 of the preferred embodiment of the present disclosure as illustrated in the figures, has a top portion 3 that fits over the nose of a user and a bottom portion 5 that covers the mouth of the user. As illustrated in FIG. 4, the mask has an inner fold 7 that extends around the entire contour of the mask 2. The inner fold 7 has a lower fold section 9 that fits over the chin of the user. The mask 2 is preferably formed of a thermoplastic elastomeric material, most preferably rubber, so that the mask can fit over the nose and chin of the user while flexibly conforming to the shape of the face of the user in order to form a tight seal around the face of the user while covering the mouth and nose. There are many types and formulations of elastomers from which the mask 2 may be constructed. Acceptable rubbers from which the mask may be constructed include natural rubber, neoprene, silicone, and many others. Plastic/polymer elastomers are typically injection molded. The polymer is melted, injected into a cavity of a mold, and cured through cooling. Kraton™ is an example of such. Where the mask is constructed of rubber, the rubber is preferably vulcanized for curing.

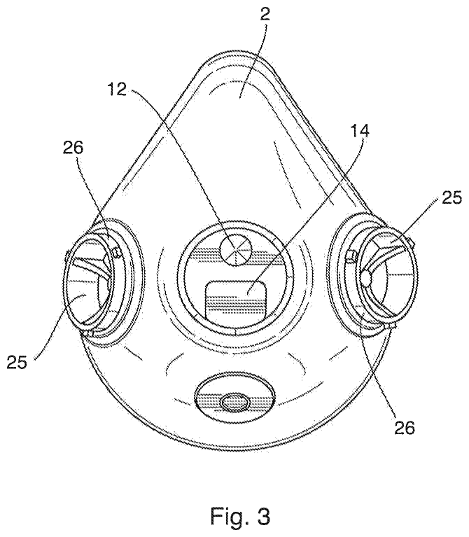

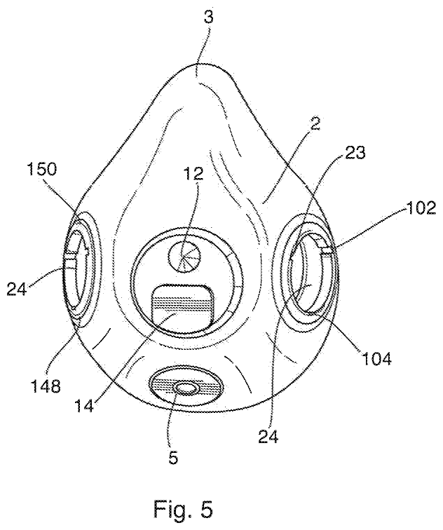

As illustrated in FIG. 5, the mask 2 defines openings 24 on the sides of the mask. The openings 24 permit air to flow into and out of the mask 2. For the purpose of connecting to a strap assembly, the mask preferably includes knob 12 formed thereon, and also preferably includes a generally rectangular protrusion 14 formed thereon. A circular protrusion shown near the bottom portion 5 of the mask in FIGS. 1-3 and 5 is not an essential feature of the mask and need not be present for the functioning of the mask.

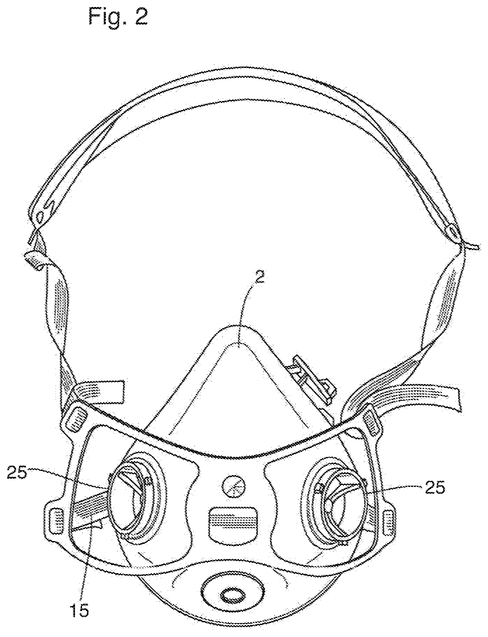

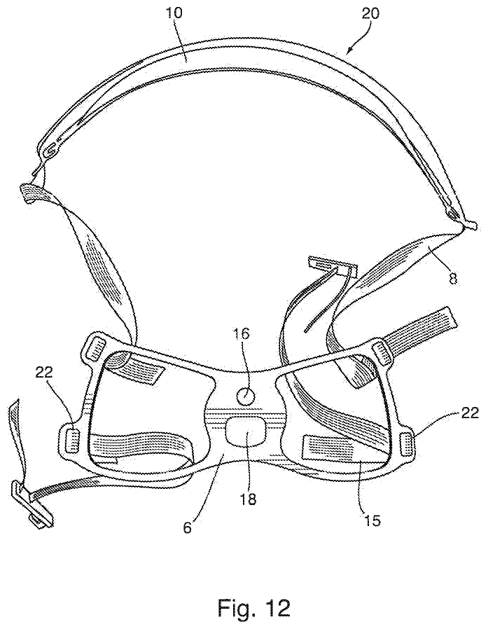

The mask is preferably secured to the face of the user by means of a strap assembly 20 shown in FIG. 12. The strap assembly 20 can be mounted to either the center of the mask or to the sides of the mask. Preferably, the mask 2 is secured to the face of the user by means of the strap assembly 20 as shown in FIG. 2, as attached to the mask 2 and in isolation in FIG. 12. The strap assembly 20 comprises a frame 6. The frame 6 is preferably generally rectangular in shape having four corners. An opening 22 is defined in the frame at each corner. A first strap 8 is attached to the openings in a top two corners of the frame 6 and a second strap 15 is received in a bottom two corners of the frame 6. The first strap 8 preferably attaches to a head support member 10.

The frame 6 has an opening 16 for attachment to the knob 12 of the mask 2. The frame 6 further includes an opening 18 for attachment to the protrusion 14. The strap assembly 20 thereby secures the mask 2 to the face of a user by means of connecting the user's head to the mask by means of the first strap 8 and head support member 10. Additionally, the second strap 15 connects a back of the user's neck to the mask 2.

Filter housings 4 are preferably removably attachable to opposing sides of the mask 2, as illustrated in FIG. 1. A filter 50 is received in each of the filter housings 4 as discussed in more detail below. The filter housings 4 are attached to the mask 2 over openings 24 such that air can flow in and out of the openings 24 and through the filter 50 located in the filter housings 4. The openings 24 preferably have a diameter in the range of about 2.15 cm to about 2.65 cm to enable a flow rate of air through the filter that allows for breathing resistance levels through the filter that meets NIOSH requirements for breathing resistance and filter efficiency while avoiding excessive heat buildup inside the mask. Most preferably, the diameter of each of the openings 24 is about 2.4 cm. Preferably, there are two filter housings 4 attached to the mask 2 wherein each of the filter housings 4 is in communication with a respective one of the openings 24 formed in the mask. However, it is possible in an alternate embodiment to provide the mask 2 with only one opening 24 and to have only a single filter in a single filter housing attached to the mask. The single filter housing could be attached to either a side or central portion of the mask 2. Importantly, the mask 2 of the present disclosure includes no separate exhalation valve or opening.

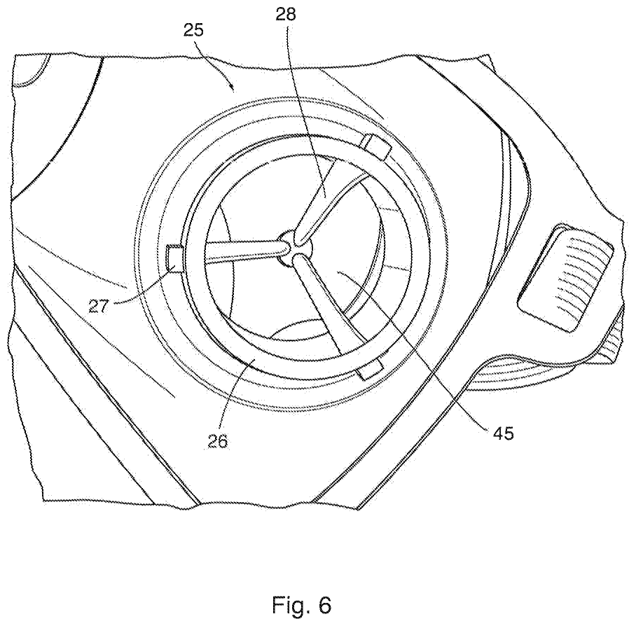

As illustrated in FIGS. 2, 3, 4 and 6, a connector is 25 is received in each of the openings 24 of the mask 2 for connecting the filter housing 4 to the mask. The connector 25 is preferably removable from the opening 24. The connector 25 includes a rim 26 for engagement against an inner surface of the opening 24 and tabs 27 formed on the rim. The openings 24 preferably define three notches 23, 102, 104 on an inner periphery of the openings 24, as shown in FIG. 5, through which tabs extend when the connector is received in the opening 24 for attachment of the connector to the filter housing 4. Preferably, the notch 23 closest to a center of the mask near knob 12 has the numeral 1 printed on the front surface of the mask beside the notch 23. Beside notch 102 there is preferably the numeral 2 printed on the front surface of the mask beside the notch 102. Similarly, beside notch 104 there is preferably the numeral 3 printed on the front surface of the mask beside the notch 104. The connector 25 is preferably a bayonet type connector with three bayonet members 28 for providing support to the connector 25. As illustrated in FIG. 4, the connector has circumferential ridge 30 for engaging against an inner surface 11 of the mask 2 when the connector is received in the opening 24. The connector defines a central opening 45 through which air can flow. The connector 25 is preferably made of a plastic material. The connector may be of one of many constructions known in in the art including screw-on, snap-on, permanently mounted filter holder on the mask in addition to twist-lock/bayonet style.

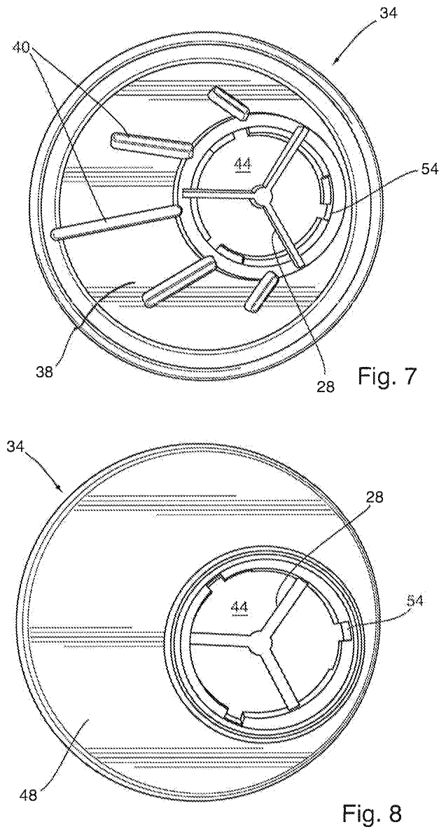

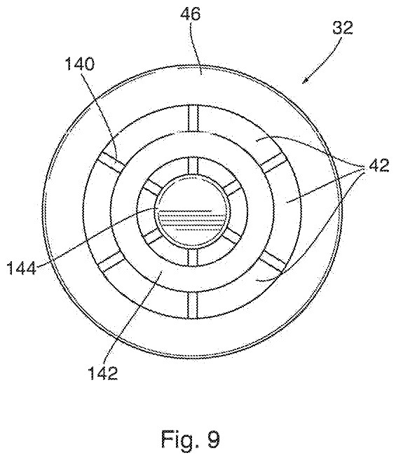

The filter housing 4 comprises an inner support member 34 shown in FIGS. 7 and 8, and an outer support member 32 as shown in FIGS. 1 and 9. The inner support member 34 is preferably detachably attachable to the outer support member 32. The filter 50 is receivable between the inner support member 34 and the outer support member 32 such that the filter 50 is sandwiched therebetween when the filter housing 4 is attached to the mask 2 during operation of the respirator.

The inner support member 34 defines an opening 44 that corresponds in shape to the opening 24 formed in the mask 2 and to the opening 45 defined by the connector. The opening 44 overlaps with the opening 24 of the mask 2 and with the opening 45 of the connector 25 when the filter housing is attached to the connector 25 with the connector 25 received in opening 24. The opening 44 of the inner support member 34 has notches 54 formed therein for cooperating with the tabs 27 of the connector 25 in order to fasten the inner support member 34 to the connector 25. The opening 44 of the inner support member 34 is offset from a center of the inner support member 34. As a result, filter housing 4 is moveable between different positions, as discussed below. This allows the user to rotate the filter housing 4 in order to fit under industrial and medical style face shields.

The filter housing 4 is adjustable between three different positions by rotating the inner support member 34 relative to the connector 25 between the three positions preferably indicated by the printing of numerals 1, 2, 3 in proximity to the respective notches 23, 102, 104, as discussed above. The corresponding notches 54 formed on the inner support member 34 engage a different one of the tabs 27 of the connector 25 upon each 60 degree rotation of the filter housing 4 between the three positions.

As best illustrated in FIG. 5, an indented sealing ring 148 is formed on the mask 2. A raised edge 150 is formed adjacent to the sealing ring 148 around the circumference thereof. This allows for a firm seal to be formed around the opening 24 when the filter housing 4 is attached to the mask 2.

FIG. 7 illustrates an inner surface 38 of the inner support member 34. The inner surface 38 of the inner support member 34 preferably has fins 40 formed thereon for creating a space between the inner surface 38 and the filter 50 that allows for the flow of air to be directed by the fins 40 into the opening 44 as the filter 50 sits on the fins 40. Preferably five fins 40 are formed on the inner surface 38 as shown in FIG. 7. The fins 40 are orientated to direct air flow over the entire filter 50 as the user inhales air into the filter housing 4. The space created by the fins between the filter 50 and the inner surface 38 of the inner support member 34 permits air to access the entire filter 50.

FIG. 8 illustrates an outer surface 48 of the inner support member 34.

As shown in FIG. 9, the outer surface 46 of the outer support member 32 defines a plurality of openings 42 formed therein for permitting air flow. There are preferably a plurality of openings formed in the outer surface of the outer support member 32 as shown in FIG. 9. The openings 42 are large in size relative to surface area of the outer surface of the outer support member. This allows for efficient air flow through the openings. The outer surface 46 of the outer support member 32 includes a central support 144 and a concentric ring support 142. Spoke members 140 connect to the central support 144 and the concentric ring support 142. The presence the larger sized openings 42 makes it more efficient to cover the openings with one hand of a user in order to carry out a negative fit check in order to verify that the mask 2 forms an appropriate seal to the user's face. This concentric ring support 142 prevents the user from touching the filter in the filter housing. This inhibits the user from touching the filter and causing contamination with a virus.

An alternate embodiment of an outer support member 82 is shown in FIG. 10. The alternate embodiment of the outer support member 82 defines openings 88 which are a series of concentric arcuate openings.

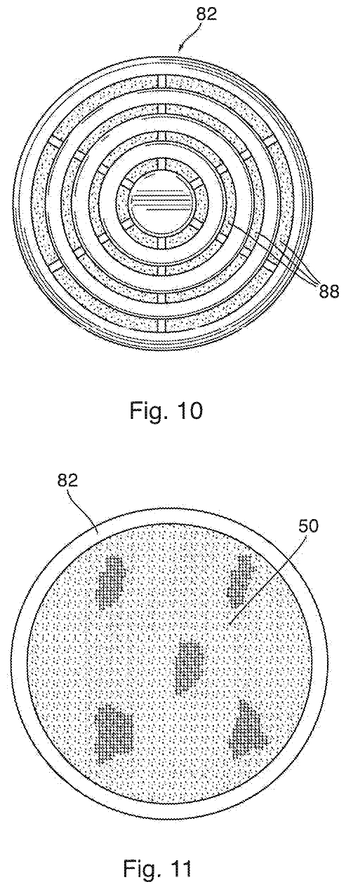

FIG. 11 illustrates the positioning of the filter 50 into the alternate embodiment of the outer support member 82. Similarly, the outer support member 32 of the preferred embodiment is adapted to receive the filter 50. The filter 50 can be initially positioned optionally into either the inner support member 34 or into the outer support member 32. The inner support member 34 and the outer support member 32 are then connected together preferably through a snap fit with the filter 50 sandwiched therebetween.

The filter housing 4 is preferably circular in shape. However other shaped filters housings can be used. Preferably the diameter of the outer support member 32 is about 3.4 inches to about 3.6 inches. Most preferably the diameter of the outer support member 32 is about 3.4 inches. Where the filter housing is of another shape, preferably, the width of the outer support member 32 is about 3.4 inches to about 3.6 inches. The inner support member 34 is sized to be connected to the outer support member 32 through a snap fit or other arrangement.

There are no inhalation valve diaphragms located in the openings 24 of the mask 2, the central opening 45 of connectors 25 or in the opening 44 of the filter housing 4, such that air can pass through the filters 50 upon exhalation. In a standard half mask configuration, inhalation diaphragms prevent exhaled air from traveling back through the filters 50.

The filter 50 is preferably one of a number filters known in the art. Filters that can be used include those known commercially as a N95 filters in addition to R95, P95, N99, R99, P99, N100, R100, or P100. The filter housing 4 will accommodate any such filters. The filter 50 of the present disclosure has inhalation and exhalation breathing resistances below the value of 25 mm per water column (mmWC) maximum required to meet NIOSH breathing resistance requirements.

The filter functions to filter out harmful particulates such as silica dust and harmful gases, vapors and other toxins. The filter also provides a barrier against viruses.

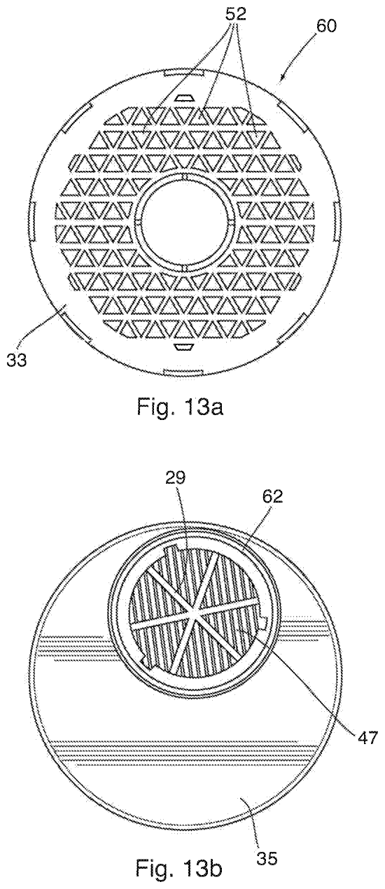

A second alternate filter housing 60 is shown in FIGS. 13a and 13b. The filter housing 60 has an inner support member 35 as shown in FIG. 13b. The inner support member 35 defines an air flow opening 29. A connector 62 is receivable in the opening of the inner support member 35 for connecting the filter housing 60 to the mask 2 in a similar manner as for filter housing 4. The connector 62 defines an air flow opening 47 for communicating with the opening 24 of the mask 2.

An outer support member 33 is shown in FIG. 13a. The outer support member 33 has a plurality of air flow openings 52 that are sized to prevent the user from touching the filter that may be contaminated with a virus. This also allows the cartridge to be disinfected and reused without affecting the filter. A filter is received between the inner support member 35 and the outer support member 33.

In operation, the user snugly attaches the mask 2 to the face of the user by means of the strap assembly 20. The head support member 10 is secured to the user's head while the second strap 15 is secured to the back of the user's neck. The first strap 8 and the second strap 15 are adjustable to snugly engage the mask to the users' face over the user's mouth and nose in order to create an airtight seal over the user's face. The airtight engagement is created by the force applied by the frame 6 against the mask 2 upon tightening of the first strap 8 and the second strap 15. In other embodiments, alternate mechanisms known in the art for securing the mask 2 to the user's face to create an airtight seal may be employed.

The mask is secured to the user's face with each of the filter housings 4 attached to the mask 2 by means of the connectors 25 disposed in the openings 24 as shown in FIG. 1. Air is both inhaled and exhaled by the user through each of the filter housings 4 which contain a filter 50.

Upon inhalation, air enters into each of the filter housings 4 through the openings 42. The suction force of the inhalation pulls the air through the filter 50. Due to the spacing created by the fins 40 between the filter 50 and the inner surface 38 of the inner support member 34, as the air passes through the filter 50, the fins direct the air flow through the airflow openings 44 in the inner support members 34. The air then passes into the mask through the openings 24 for inhalation by the user after passing through the air openings 45 in the connectors 25.

Air is exhaled from the mask 2 by the user through openings 24 and through the air openings 45 in the connectors 25. The pressure created by the exhalation then pushes the air into each filter housing 4 through the airflow opening 44 in the inner support member 34. This is due to the fact that there is no separate exhalation valve or other opening through which air can be exhaled from the mask. The air then passes through the filter 50 and out into the external environment through the openings 42.

The filter functions to filter out harmful particulates such as silica dust and harmful gases, vapors and other toxins including bacteria and viruses from the environment upon inhalation of air through the filters by the user. Upon exhalation of air by the user back into the environment, the filters function to provide a barrier against the spread of bacteria and viruses such as Covid-19. This offers to protection to co-workers operating in the same surrounding environment. As a result of the respirator of the present disclosure having no separate exhalation valve, air is inhaled and exhaled through the same filters. As a result, the respirator of the present disclosure, provides the dual function of protecting the user against harmful particulates, harmful gases and vapors while also offering protection to co-workers and others against the spread of harmful viruses such as Covid-19. This dual function is accomplished while properly maintaining an effective seal, avoiding excessive heat buildup within the mask and maintaining comfort for the user while wearing the sealed mask thereby increasing productivity of the user in carrying out his or her work.

Although the invention has been described in detail with reference to certain preferred embodiments, variations and modifications exist within the spirit and scope of the invention as described and defined in the following claims.

1. A respirator, comprising:
a mask configured to snugly fit over a mouth and a nose of a user in order to form an airtight seal over the mouth and the nose of the user; said mask defining an opening for permitting airflow through said opening;
a replaceable filter being attachable to the mask over said opening of said mask,
wherein the mask is airtight such that upon sealing engagement of the mask over the mouth and the nose of the user, air flows through the replaceable filter into the mask upon inhalation of the user and wherein air flows out of the mask through the filter upon exhalation of the user.

2. The respirator of claim 1 wherein the mask does not include a separate exhalation valve or opening.

3. The respirator of claim 2 wherein the mask defines two openings for permitting airflow through said openings, a separate replaceable filter being attachable to the mask over a respective one of said openings wherein air flows through the filters into the mask upon inhalation of the user and wherein air flows out of the mask through the filters upon exhalation of the user.

4. The respirator according to claim 3 wherein each of the replaceable filters is received in a separate filter housing, each of said filter housings being detachably attachable to said mask over a respective one of said openings of said mask, each of the filter housings having an inner support member attachable to one of said openings, and an outer support member, each of the filter housings defining an internal space between the inner support member and an the outer support member for receiving an air filter, the inner support member defining an airflow opening in airflow communication with the opening of the mask when the filter housing is attached to the mask, the outer support member defining an airflow opening

5. The respirator of claim 1, further comprising a strap for snugly attaching the mask to the face of the user to create a seal on the face of the user, the strap having a first end attached to the mask and second end for attachment to a rear portion of the head of user.

6. The respirator of claim 4, further comprising a connector received in each of said openings of said mask for connection to a respective one of said inner support members of the filter housings, each of the connectors defining an airflow opening in airflow communication with both the airflow opening the inner support member of the filter housing and with the opening of the mask.

7. The respirator of claim 6 wherein the connector is a bayonet style connector.

8. The respirator of claim 1 wherein the mask is formed of an elastomeric material or silicone.

9. The respirator of claim 6 wherein the elastomeric material is rubber.

10. The respirator of claim 1 wherein the filter has a width or a diameter of about 8.5 cm.

11. The respirator of claim 1 wherein the opening formed in said mask has a diameter in a range of about 2.15 cm to about 2.65 cm.

12. The respirator of claim 1, further comprising a filter located in the filter housing wherein the filter has an inhalation breathing resistance of 11.5 mm per water column (mmWC) at 85 litres per minute (LPM) and an exhalation breathing resistance of 10.5 mmWC at 85 LPM.

13. The respirator of claim 1, further comprising a filter located in the filter housing wherein the filter is one of a N95 filter pad, a P100 filter pad and a R95 filter pad.

14. The respirator of claim 4 wherein the inner support member has an inner surface, a plurality of fins being formed on the inner surface.

15. A respirator, comprising:
a mask configured to snugly fit over the mouth and nose of a user in order to form an airtight seal over the mouth and nose of the user; said mask defining two openings for permitting airflow through said openings;
two filter housings, each of said two filter housings being detachably attachable to said mask over a respective one of said openings of said mask, each of the filter housings having an inner support member attachable to one of said openings and an outer support member, each of the filter housings defining an internal space between the inner support member and an outer support member for receiving an air filter, the inner support member defining an airflow opening in airflow communication with the opening of the mask when the filter housing is attached to the mask, the outer support member defining an airflow opening;
wherein the mask is airtight such that upon sealing engagement of the mask over the mouth and nose of a user, air flows through the filter housings into the mask upon inhalation of the user and wherein air flows out of the mask through the filter housings upon exhalation of the user.

16. The respirator of claim 15 wherein the mask does not include a separate exhalation valve or opening.

17. The respirator of claim 16, further comprising two connectors, each of said two connectors being received in a respective one of said openings of said mask for connection to a respective one of said inner support members of the filter housings, each of the connectors defining an airflow opening in airflow communication with both the airflow opening the inner surface of the filter housing and with the opening of the mask.

18. The respirator of claim 16 wherein the openings formed in said mask have a diameter in a range of about 2.15 cm to about 2.65 cm.

19. The respirator of claim 16, further comprising a filter located in each filter housing wherein the filter has an inhalation breathing resistance of 11.5 mm per water column (mmWC) at 85 litres per minute (LPM) and an exhalation breathing resistance of 10.5 mmWC at 85 LPM.

20. The respirator of claim 16 wherein the outer surfaces of the filter housings define a plurality of airflow openings.
